(19) United States
(12) Patent Application Publication
(10) Pub. No.: US 2011/0249130 A1
(43) Pub. Date: Oct. 13, 2011

(54) ELECTRONIC CAMERA

(75) Inventors: Takeshi FUJIWARA, Osaka (JP); Seiji Yamamoto, Daito-shi (JP)

(73) Assignee: Sanyo Electric Co., Ltd., Osaka (JP)

(21) Appl. No.: 13/083,771

(22) Filed: Apr. 11, 2011

(30) Foreign Application Priority Data
Apr. 12, 2010 (JP) 2010-091316

(51) Int. Cl. H04N 5/228

(52) U.S. Cl. 348/208.3; 348/222.1; 348/208.99; 348/E05.031

(57) ABSTRACT

An electronic camera includes an imager. An imager repeatedly outputs an image representing a scene captured by an imaging surface. An adjuster adjusts an imaging condition by referring to any one of a plurality of adjustment references including a specific adjustment reference suitable for a dynamic scene. A permitter permits the referring by the adjuster to the specific adjustment reference when a movement of the image outputted from the imager satisfies a first condition and a luminance of the image outputted from the imager satisfies a second condition. A restrictor restricts the referring by the adjuster to the specific adjustment reference when at least one of the first condition and the second condition is not satisfied.

### CROSS REFERENCE OF RELATED APPLICATION

The disclosure of Japanese Patent Application No. 2010-91316, which was filed on Apr. 12, 2010, is incorporated here by reference.

### BACKGROUND OF THE INVENTION

1. Field of the Invention

The present invention relates to an electronic camera. More particularly, the present invention relates to an electronic camera which refers to a movement of a scene image outputted from an imaging device so as to adjust an imaging condition.

2. Description of the Related Art

According to one example of this type of a camera, a plurality of motion vectors respectively corresponding to a plurality of locations of an imaging surface are detected based on image data outputted from an imaging portion. A movement of the camera is specified by performing a majority operation on the plurality of detected motion vectors. The image data outputted from the imaging portion is stored in an image storing portion. A location of one portion of the image data, which should be read out from an image recording portion for a purpose of display, is adjusted so that a camera shake is corrected when the movement of the camera specified by the majority operation is equivalent to the camera shake.

However, in the above-described camera, an attribute of a scene is not determined based on the plurality of motion vectors detected corresponding to the plurality of positions of the imaging surface, and an adjustment reference of the imaging condition is not set in a manner to differ depending on each determined attribute, either. Thus, the imaging performance of the above-described camera is limited.

### SUMMARY OF THE INVENTION

An electronic camera according to the present invention comprises: an imager which repeatedly outputs an image representing a scene captured by an imaging surface; an adjuster which adjusts an imaging condition by referring to any one of a plurality of adjustment references including a specific adjustment reference suitable for a dynamic scene; a permitter which permits the referring by the adjuster to the specific adjustment reference when a movement of the image outputted from the imager satisfies a first condition and a luminance of the image outputted from the imager satisfies a second condition; and a restrictor which restricts the referring by the adjuster to the specific adjustment reference when at least one of the first condition and the second condition is not satisfied.

According to the present invention, a computer program embodied in a tangible medium, which is executed by a processor of an electronic camera provided with an imager which repeatedly outputs an image representing a scene captured by an imaging surface, the program comprising: an adjusting instruction to adjust an imaging condition by referring to any one of a plurality of adjustment references including a specific adjustment reference suitable for a dynamic scene; a permitting instruction to permit the referring in the adjusting instruction to the specific adjustment reference when a movement of the image outputted from the imager satisfies a first condition and a luminance of the image outputted from the imager satisfies a second condition; and a restricting instruction to restrict the referring in the adjusting instruction to the specific adjustment reference when at least one of the first condition and the second condition is not satisfied.

According to the present invention, an imaging controlling method executed by an electronic camera provided with an imager which repeatedly outputs an image representing a scene captured by an imaging surface, the image controlling method, comprising: an adjusting step of adjusting an imaging condition by referring to any one of a plurality of adjustment references including a specific adjustment reference suitable for a dynamic scene; a permitting step of permitting the referring in the adjusting step to the specific adjustment reference when a movement of the image outputted from the imager satisfies a first condition and a luminance of the image outputted from the imager satisfies a second condition; and a restricting step of restricting the referring in the adjusting step to the specific adjustment reference when at least one of the first condition and the second condition is not satisfied.

The above described features and advantages of the present invention will become more apparent from the following detailed description of the embodiment when taken in conjunction with the accompanying drawings.

### BRIEF DESCRIPTION OF THE DRAWINGS

FIG. 1 is a block diagram showing a basic configuration of one embodiment of the present invention;

FIG. 2 is a block diagram showing a configuration of one embodiment of the present invention;

FIG. 3 is an illustrative view showing one example of a configuration of a color filter applied to the embodiment in FIG. 2;

FIG. 4 is an illustrative view showing one example of an allocation state of a cut-out area in an imaging surface;

FIG. 5 is an illustrative view showing one example of an allocation state of an evaluation area in the imaging surface;

FIG. 6 is an illustrative view showing one example of an allocation state of a motion detection block in the imaging surface;

FIG. 7(A) is an illustrative view showing one example of a character corresponding to a night-view scene;

FIG. 7(B) is an illustrative view showing one example of a character corresponding to an action scene;

FIG. 7(C) is an illustrative view showing one example of a character corresponding to a landscape scene;

FIG. 7(D) is an illustrative view showing one example of a character corresponding to a default scene;

FIG. 8 is an illustrative view showing one example of a configuration of a register applied to the embodiment in FIG. 2;

FIG. 9 is an illustrative view showing one example of a scene captured by the imaging surface;

FIG. 10 is an illustrative view showing another example of the scene captured by the imaging surface;

FIG. 11 is a graph showing one example of a program chart corresponding to the night-view scene;

FIG. 12 is a graph showing one example of a program chart corresponding to the action scene;

FIG. 13 is a graph showing one example of a program chart corresponding to the landscape scene;

FIG. 14 is a graph showing one example of a program chart corresponding to the default scene;

FIG. 15 is a flowchart showing one portion of behavior of a CPU applied to the embodiment in FIG. 2;

FIG. 16 is a flowchart showing another portion of the behavior of the CPU applied to the embodiment in FIG. 2;

FIG. 17 is a flowchart showing still another portion of the behavior of the CPU applied to the embodiment in FIG. 2;

FIG. 18 is a flowchart showing yet another portion of the behavior of the CPU applied to the embodiment in FIG. 2;

FIG. 19 is a flowchart showing another portion of the behavior of the CPU applied to the embodiment in FIG. 2;

FIG. 20 is a flowchart showing still another portion of the behavior of the CPU applied to the embodiment in FIG. 2;

FIG. 21 is a flowchart showing yet another portion of the behavior of the CPU applied to the embodiment in FIG. 2;

FIG. 22 is a flowchart showing another portion of the behavior of the CPU applied to the embodiment in FIG. 2;

FIG. 23 is a flowchart showing still another portion of the behavior of the CPU applied to the embodiment in FIG. 2;

FIG. 24 is a flowchart showing yet another portion of the behavior of the CPU applied to the embodiment in FIG. 2;

FIG. 25 is a flowchart showing another portion of the behavior of the CPU applied to the embodiment in FIG. 2; and

FIG. 26 is a flowchart showing still another portion of the behavior of the CPU applied to the embodiment in FIG. 2.

### DETAILED DESCRIPTION OF THE PREFERRED EMBODIMENTS

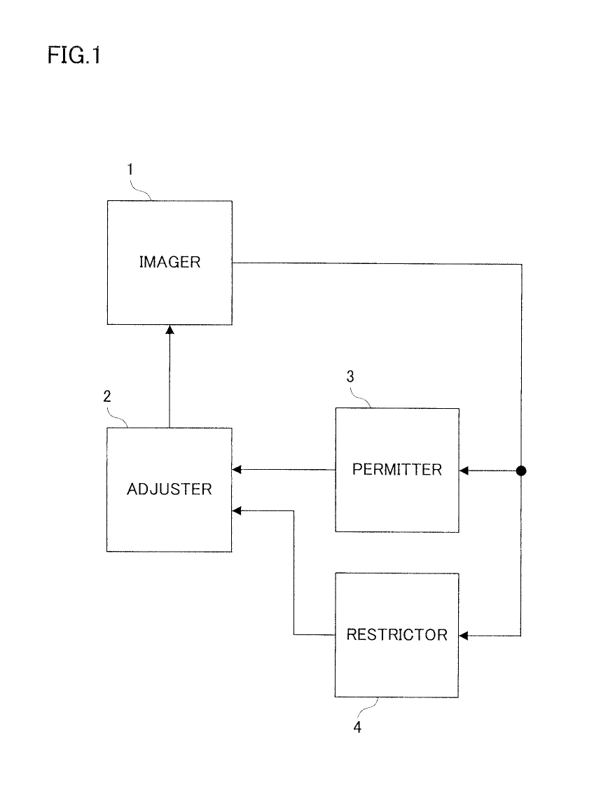

With reference to FIG. 1, an electronic camera according to one embodiment of the present invention is basically configured as follows: an imager 1 repeatedly outputs an image representing a scene captured by an imaging surface. An adjuster 2 adjusts an imaging condition by referring to any one of a plurality of adjustment references including a specific adjustment reference suitable for a dynamic scene. A permitter 3 permits the referring by the adjuster 2 to the specific adjustment reference when a movement of the image outputted from the imager 1 satisfies a first condition and a luminance of the image outputted from the imager 1 satisfies a second condition. A restrictor 4 restricts the referring by the adjuster 2 to the specific adjustment reference when at least one of the first condition and the second condition is not satisfied.

Therefore, the referring to the specific adjustment reference suitable for the dynamic scene is permitted when the movement of the image satisfies the first condition and the luminance of the image satisfies the second condition. In other words, the referring to the specific adjustment reference is restricted even when the movement of the image satisfies the first condition, if the luminance of the image does not satisfy the second condition. This avoids an erroneous determination of whether or not the scene captured by the imaging surface is dynamic, by extension, an erroneous selection of the adjustment reference, and improves an imaging performance.

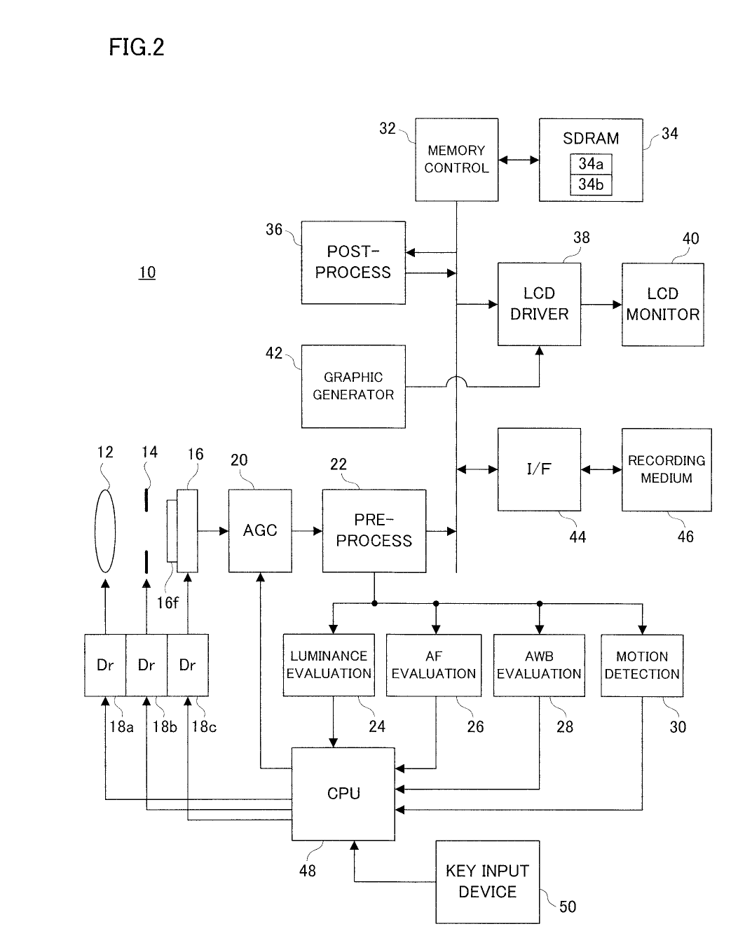

With reference to FIG. 2, a digital video camera 10 according to one embodiment includes a focus lens 12 and an aperture unit 14 driven by drivers 18a and 18b, respectively. Through these members, an optical image of a scene enters, with irradiation, an imaging surface of an image sensor 16.

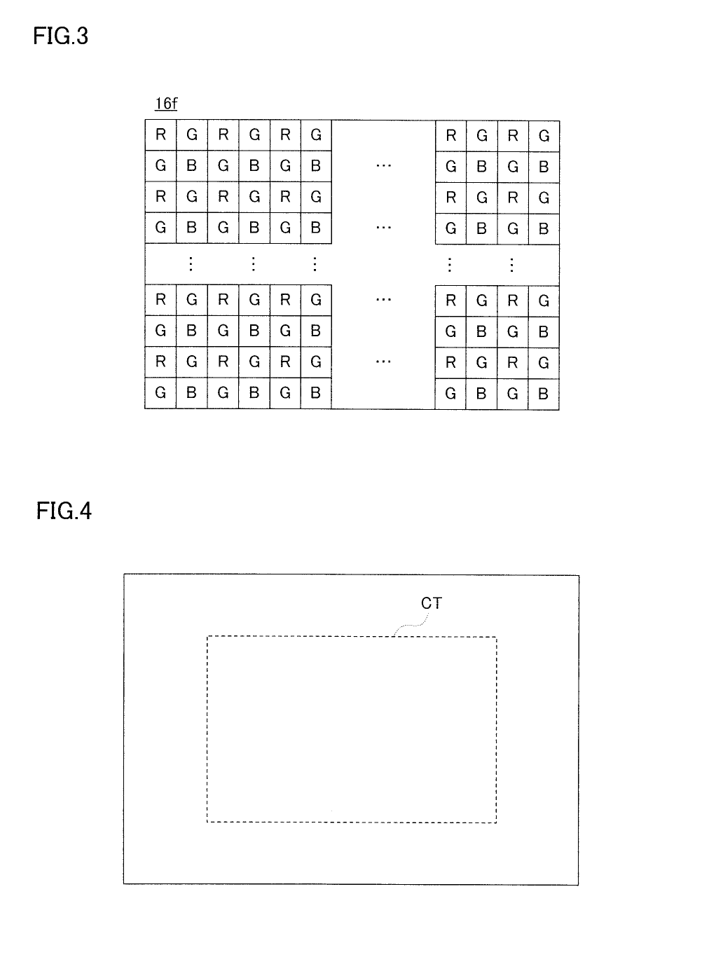

A plurality of light receiving elements (=pixels) are placed two-dimensionally on the imaging surface, and the imaging surface is covered with a primary color filter 16f having a Bayer array shown in FIG. 3. Specifically, the color filter 16f is equivalent to a filter in which a filter factor of R (Red), a filter factor of G (Green), and a filter factor of B (Blue) are arrayed in mosaic. The light receiving elements placed on the imaging surface correspond one by one to the filter factors configuring the color filter 16f, and an amount of electric charges produced by each light receiving element reflects an intensity of light corresponding to color of R, or B.

When a power source is applied, a CPU 48 starts up a driver 18c in order to execute a moving-image taking process under an imaging task. In response to a cyclically-generated vertical synchronization signal Vsync, the driver 18c exposes the imaging surface and reads out the electric charges produced on the imaging surface in a raster scanning manner. From the image sensor 16, raw image data representing the scene is cyclically outputted. The outputted raw image data is equivalent to image data in which each pixel has color information of any one of R, G, and B.

An AGC circuit 20 amplifies the raw image data outputted from the image sensor 16 by referring to an AGC gain set by the CPU 48. A pre-processing circuit 22 performs processes, such as digital clamp and a pixel defect correction, on the raw image data amplified by the AGC circuit 20. The raw image data on which such a pre-process is performed is written, through a memory control circuit 32, into a raw image area 34a of an SDRAM 34.

With reference to FIG. 4, a cut-out area CT is allocated to the raw image area 34a. A post-processing circuit 36 accesses the raw image area 34a through the memory control circuit 32 so as to cyclically read out the raw image data belonging to the cut-out area CT. The read-out raw image data is subjected to processes, such as a color separation, a white balance adjustment, an edge/chroma emphasis, and a YUV conversion, in the post-processing circuit 36.

Firstly, the raw image data is converted to RGB-formatted image data, in which each pixel has all the color information items of R, G, and B, by the color separating process. A white balance of the image data is adjusted by a white-balance adjusting process, an edge and/or a chroma of the image data is emphasized by an edge/chroma emphasizing process, and a format of the image data is converted to a YUV format by a YUV converting process. The YUV-formatted image data created in this way is written, through the memory control circuit 32, into a YUV image area 34b of the SDRAM 34.

An LCD driver 38 cyclically reads out the image data accommodated in the YUV image area 34b, reduces the read-out image data so as to be adapted to a resolution of an LCD monitor 40, and drives the LCD monitor 40 based on the reduced image data. As a result, a real-time moving image (live view image) representing the scene is displayed on a monitor screen.

With reference to FIG. 5, an evaluation area EVA is allocated to a center of the imaging surface. The evaluation area EVA is divided into 16 portions in each of a horizontal direction and a vertical direction, and this means that the evaluation area EVA is formed by a total of 256 divided areas.

In addition to the above-described process, the pre-processing circuit 22 performs a process of simply converting the raw image data into Y data, and applies the converted Y data to the luminance evaluating circuit 24, the AF evaluating circuit 26, and the motion detecting circuit 30. Moreover, the pre-processing circuit 22 performs a process of simply converting the raw age data into RGB image data (RGB image data having a white balance adjusted according to an initial gain), and applies the converted RGB image data to an AWB evaluating circuit 28.

In response to the vertical synchronization signal Vsync, the luminance evaluating circuit 24 integrates Y data belonging to the evaluation area EVA, out of the applied Y data, for each divided area. From the luminance evaluating circuit 24, the 256 luminance evaluation values are outputted in synchronization with the vertical synchronization signal Vsync. The CPU 48 takes the luminance evaluation values thus outputted under a brightness adjusting task, calculates an appropriate BV value (BV: Brightness Value) based on the taken luminance evaluation values, and sets an aperture amount, an exposure time, and an AGC gain that define the calculated appropriate BV value, to the drivers 18b and 18c and the AGC circuit 20. As a result, the brightness of the live view image is adjusted moderately.

In response to the vertical synchronization signal Vsync, the AF evaluating circuit 26 integrates a high frequency component of Y data belonging to the evaluation area EVA, out of the applied Y data, for each divided area. From the AF evaluating circuit 26, 256 AF evaluation values are outputted in synchronization with the vertical synchronization signal Vsync. The CPU 48 takes the AF evaluation values thus outputted under a continuous AF task, and executes an AF process when an AF start-up condition is satisfied. The focus lens 12 is placed at a focal point by the driver 18a, and as a result, a sharpness of the live view image is continuously improved.

In response to the vertical synchronization signal Vsync, the AWB evaluating circuit 28 integrates each of R data, G data, and B data that form the applied RGB image data, for each divided area. From the AWB evaluating circuit 28, 256 AWB evaluation values, each of which has an R integral value, a G integral value, and a B integral value, are outputted in synchronization with the vertical synchronization signal Vsync. The CPU 48 takes the AWB evaluation values thus outputted under an AWB task, and executes an AWB process based on the taken AWB evaluation values. The white-balance adjustment gain referred to in the post-processing circuit 36 is adjusted to an appropriate value by the AWB process, and a tonality of the live view image is thereby adjusted moderately.

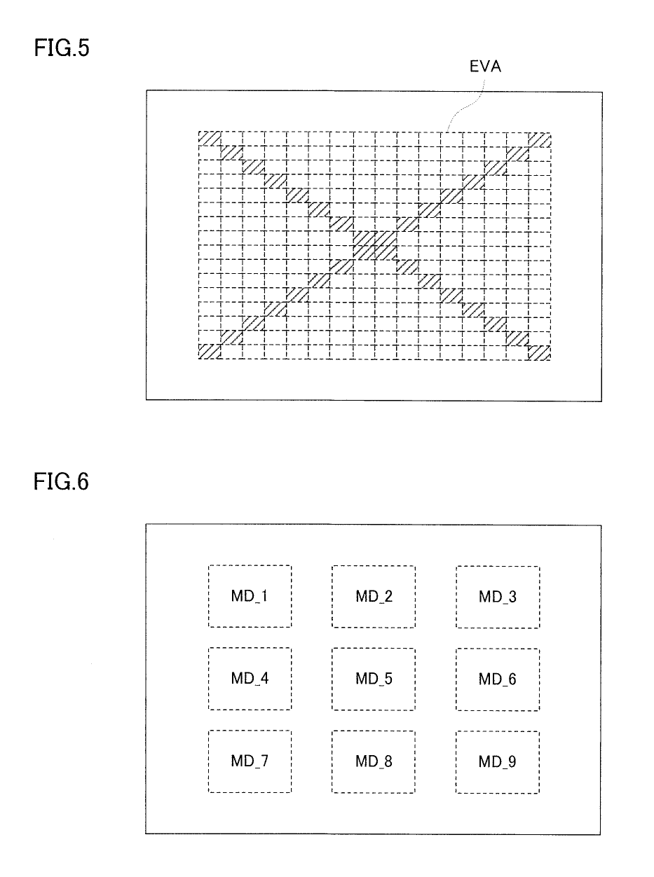

With reference to FIG. 6, nine motion detection blocks MD_1 to MD_9 are allocated to the imaging surface. The motion detection blocks MD_1 to MD_3 are placed to be aligned in a horizontal direction at an upper level of the imaging surface, the motion detection blocks MD_4 to MD_6 are placed to be aligned in a horizontal direction at a medium level of the imaging surface, and the motion detection blocks MD_7 to MD_9 are placed to be aligned in a horizontal direction at a lower level of the imaging surface.

The motion detecting circuit 30 detects partial motion vectors MV_1 to MV_9 respectively corresponding to the motion detection blocks MD_1 to MD_9, based on the Y data. The detected partial motion vectors MV_1 to MV_9 are outputted from the motion detecting circuit 30 in synchronization with the vertical synchronization signal Vsync. The CPU 48 takes the outputted partial motion vectors MV_1 to MV_9 under an image-stabilizing task, and based thereon, executes an image-stabilizing process. When a movement of the imaging surface in a direction orthogonal to an optical axis is equivalent to a camera shake of the imaging surface, the cut-out area CT moves in a direction to compensate this camera shake. This inhibits a live-view-image vibration resulting from the camera shake.

When a recording start operation is performed on a key input device 50, the CPU 48 applies a recording start command to an I/F 44 under an imaging task in order to start a moving image recording. The I/F 44 reads out the image data accommodated in the YUV image area 34b through the memory control circuit 32, and writes the read-out image data into a moving-image file created in a recording medium 46. When a recording end operation is performed on the key input device 50, the CPU 48 applies a recording end command to the I/F 44 under the imaging task in order to end the moving image recording. The I/F 44 ends reading out the image data, and closes the moving-image file of a recording destination.

The CPU 48 cyclically determines to which one of the night-view scene, the action scene, and the landscape scene the captured scene is equivalent, under a scene determining task executed in parallel with the imaging task. The night-view scene determination and the landscape scene determination are executed based on the luminance evaluation values outputted from the luminance evaluating circuit 24. When the captured scene is determined to be the night-view scene, a flag FLGnight is updated from “0” to “1”, and when the captured scene is determined to be the landscape scene, a flag FLGlndscp is updated from “0” to “1”. Moreover, the action scene determination is executed based on the partial motion vectors MV_1 to MV_9 outputted from the motion detecting circuit 30 and the luminance evaluation values outputted from the luminance evaluating circuit 24. When the captured scene is determined to be the action scene, the flag FLGact is updated from “0” to “1”.

When the flag FLGnight is “1”, the night-view scene is regarded as a finalized scene irrespective of statuses of the flag FLGlndscp and FLGact. Moreover, when the flag FLGnight is “0” and the flag FLGact is “1”, the action scene is regarded as a finalized scene irrespective of a status of the flag FLGlndscp. Further, when the flag FLGnight and the FLGact are “0” and the flag FLGlndscp is “1”, the landscape scene is regarded as the finalized scene. Moreover, when all of the flags FLGnight, FLGact, and FLGlndscp are “0”, the default scene is regarded as the finalized scene.

The CPU 48 requests a graphic generator 42 to output a character corresponding to the finalized scene thus obtained. The graphic generator 42 applies graphic data that responds to the request, to the LCD driver 38, and the LCD driver 38 drives the LCD monitor 40 based on the applied graphic data.

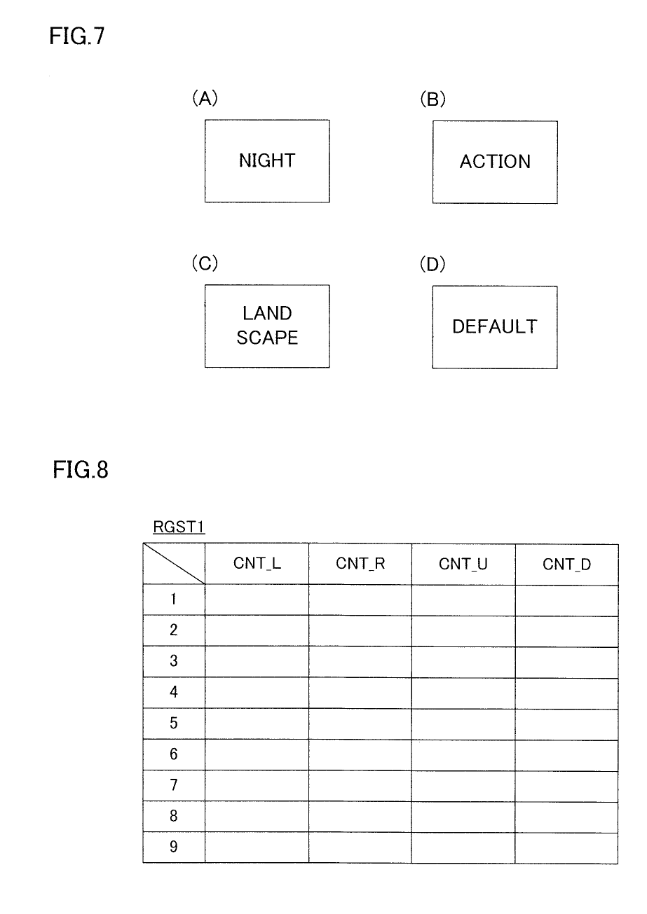

As a result, if the finalized scene is the night-view scene, then a character shown in FIG. 7(A) is displayed at an upper right of the monitor screen, and if the finalized scene is the action scene, a character shown in FIG. 7(B) is displayed at the upper right of the monitor screen. Moreover, if the finalized scene is the landscape scene, then a character shown in FIG. 7(C) is displayed at the upper right of the monitor screen, and if the finalized scene is the default scene, a character shown in FIG. 7(D) is displayed at the upper right of the monitor screen.

More particularly, the action scene determination is executed according to the following procedure. Firstly, variables CNT_L, CNT_R, CNT_U, and CNT_D initialized to “0” in each frame are updated in a manner different depending on a magnitude and a direction of a partial motion vector MV_J (J:1˜9) detected in each frame.

The variable CNT_L is incremented when a horizontal component amount of the partial motion vector MV_J exceeds an amount equivalent to five pixels in a left direction. The variable CNT_R is incremented when the horizontal component amount of the partial motion vector MV_J exceeds an amount equivalent to five pixels in a right direction. The variable CNT_U is incremented when a vertical component amount of the motion vector MV_J exceeds an amount equivalent to five pixels in an upper direction. The variable CNT_D is incremented when the vertical component amount of the motion vector MV_J exceeds an amount equivalent to five pixels in a lower direction.

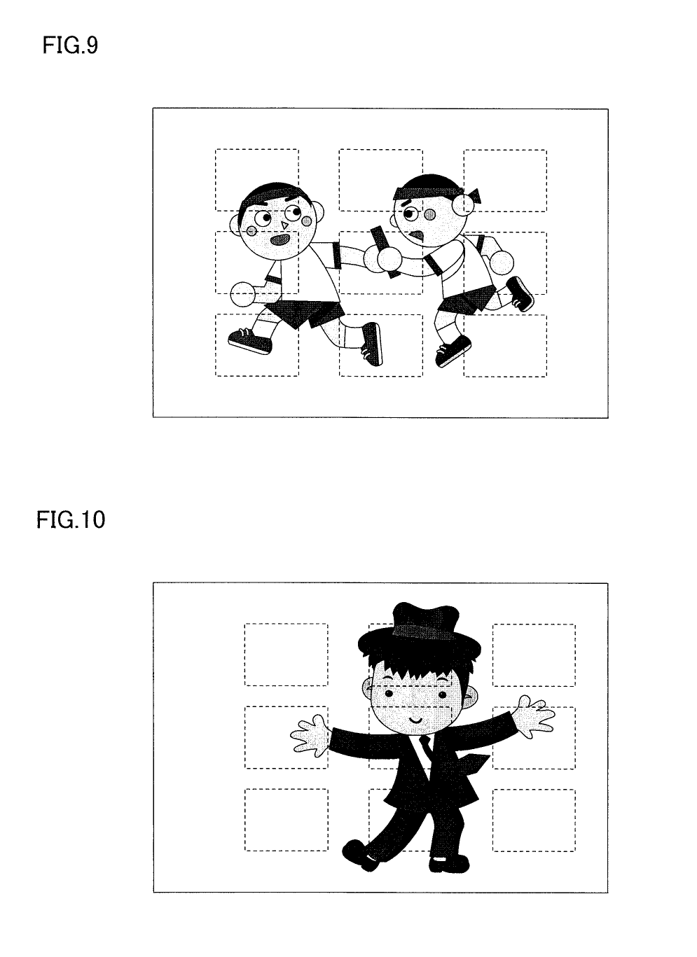

Upon completion of the above-described process on each of the partial motion vectors MV_1 to MV_9, values of the variables CNT_L, CNT_R, CNT_U, and CNT_D are registered in a K-th column of a register RGST1 shown in FIG. 8. A variable K is a variable updated in circulation among “1” and “9” in response to the vertical synchronization signal Vsync, and the value registered in the K-th column of the register RGST1 represents the movement of the scene image in the K-th frame.

Subsequently, a moving amount of the cut-out area CT in the K-th frame is detected as “MVct”. If the detected moving amount MVct exceeds a threshold value THmv, then it is regarded that a non-negligible amount of image stabilization has been executed, and the variable CNT_MV to be initialized to “0” in every ninth frame is incremented.

When the value of the variable K reaches “9”, the following processes are additionally executed in order to finalize the value of the flag FLGact to one of “0” and “1”.

Firstly, the variable CNT_MV is compared with a threshold value THcntmv. If the variable CNT_MV is equal to or more than the threshold value THcntmv, then it is regarded that the movement of the scene image in the latest nine frames results from the camera shake. At this time, the value of the flag FLGact is finalized to “0”.

If the variable CNT_MV is less than the threshold value THmvcnt, then it is regarded that the movement of the scene image in the latest nine frames does not result from the camera shake. In this case, a maximum luminance evaluation value and a minimum luminance evaluation value are detected from among the 256 luminance evaluation values corresponding to the present frame, and a difference between the detected maximum luminance evaluation value and minimum luminance evaluation value is calculated as “ΔY”.

The calculated difference ΔY is compared with each of threshold values THy1 and THy2. Here, the threshold value THy1 is smaller than the threshold value THy2. If the difference ΔY is equal to or less than the threshold value THy1, then it is regarded that a luminance difference on the scene image is very small, and if the difference ΔY is equal to or more than the threshold value THy2, then it is regarded that the luminance difference on the scene image is very large. At this time, the value of the flag FLGact is finalized to “0”.

When the difference ΔY belongs to a range which exceeds the threshold value THy1 and falls below the threshold value THy2, it is regarded that the luminance difference on the scene image is appropriate. In this case, 32 luminance evaluation values respectively corresponding to 32 divided areas (divided areas to be hatched in FIG. 5) where a letter “X” is drawn so that the center of the evaluation area EVA is an intersection point thereof are detected from among the 256 luminance evaluation values corresponding to the current frame, and the degree of uniformity of the detected 32 luminance evaluation values is calculated as “Yflat”.

It is noted that the degree of uniformity Yflat is equivalent to an inverse number of a divided value obtained by dividing the difference between the maximum luminance evaluation value and the minimum luminance evaluation value forming the detected 32 luminance evaluation values by a predetermined value.

The calculated degree of uniformity Yflat is compared with the threshold value THflat. When the degree of uniformity Yflat is equal to or less than the threshold value THflat, it is regarded that the description of the register RGST1 lacks reliability to determine the movement of the scene image. At this time, the value of the flag FLGact is finalized to “0”.

When the degree of uniformity Yflat exceeds the threshold value THflat, it is determined whether or not the movement of the scene image in the latest nine frames satisfies a pan/tilt condition by referring to the description of the register RGST1. The pan/tilt condition is equivalent to a condition under which the five motion detection areas or more, out of the motion detection areas MV_1 to MV_9, indicate a movement in the same direction throughout a period of five frames or more. When the pan/tilt condition is satisfied, it is regarded that the movement to be noticed results from pan/tilt behavior of the imaging surface. At this time, the value of the flag FLGact is finalized to “0”.

When the pan/tilt condition is not satisfied, it is determined whether or not the movement of the scene image in the latest nine frames satisfies an object traversing condition and the movement of the scene image in the latest nine frames satisfies an object moving condition, by referring to the description of the register RGST1.

The object traversing condition is equivalent to a condition under which the three motion detection areas or more, out of the motion detection areas MV_1 to MV_9, indicate the movement in the same direction throughout a period of five frames or more and movements in mutually opposite directions do not appear throughout a period of the latest nine frames. The object moving condition is equivalent to a condition under which the four motion detection areas or more, out of the motion detection areas MV_1 to MV_9, indicate a movement in the same direction throughout a period of five frames or more.

The object traversing condition is satisfied when a person who traverses the scene, as shown in FIG. 9, is captured on the imaging surface. Moreover, the object moving condition is satisfied when a person who demonstrates dancing, as shown in FIG. 10, is captured on the imaging surface.

When the object traversing condition is not satisfied, it is regarded that the movement of the scene image in a period of the latest nine frames does not result from the traversing of the object. At this time, the value of the flag FLGact is finalized to “0”. Moreover, when the object moving condition is not satisfied, it is regarded that the movement of the scene image in a period of the latest nine frames does not result from the movement of an object present at the same position. At this time also, the value of the flag FLGact is finalized to “0”.

On the other hand, when either the object traversing condition or the object moving condition is satisfied, it is regarded that the movement of the scene image in a period of the latest nine frames results from the traversing of the object or the movement of the object present at the same position. At this time, the f lag FLGact is finalized to “1”.

More particularly, the process under the brightness adjusting task is executed according to the following procedure: Firstly, the aperture amount, the exposure time, and the AGC gain are initialized, and a program chart adapted to the default scene (=initial finalized scene) is designated as a referring program chart. When the vertical synchronization signal Vsync is generated, the appropriate BV value is calculated based on the luminance evaluation values outputted from the luminance evaluating circuit 24, and coordinates (A, T, G) corresponding to the calculated appropriate BV value are detected from the referring program chart. It is noted that “A” corresponds to the aperture amount, “T” corresponds to the exposure time, and “G” corresponds to the AGC gain.

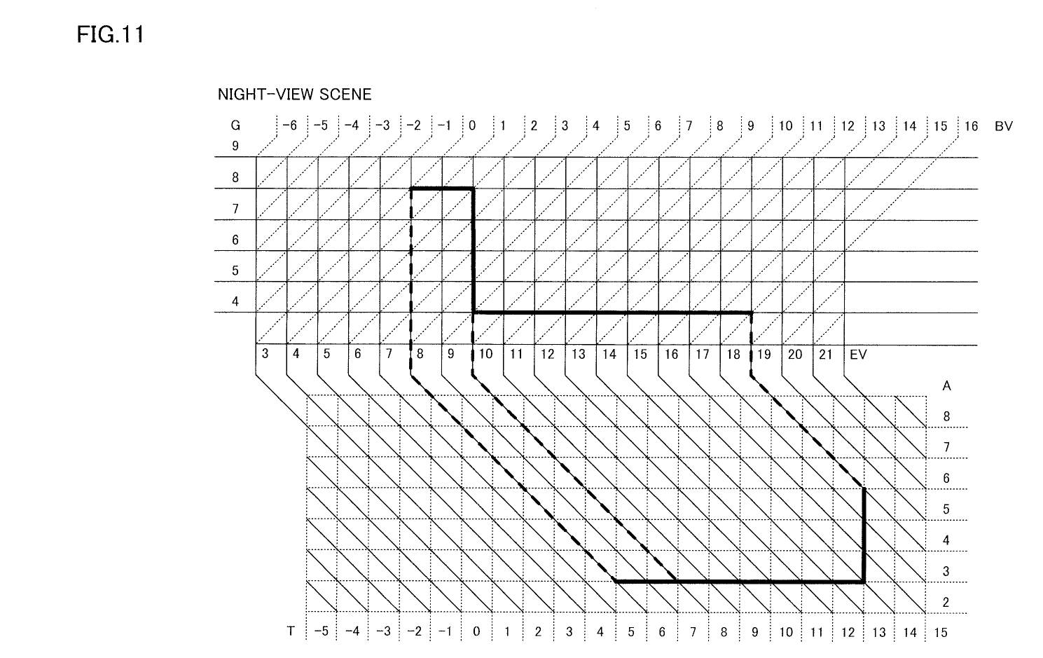

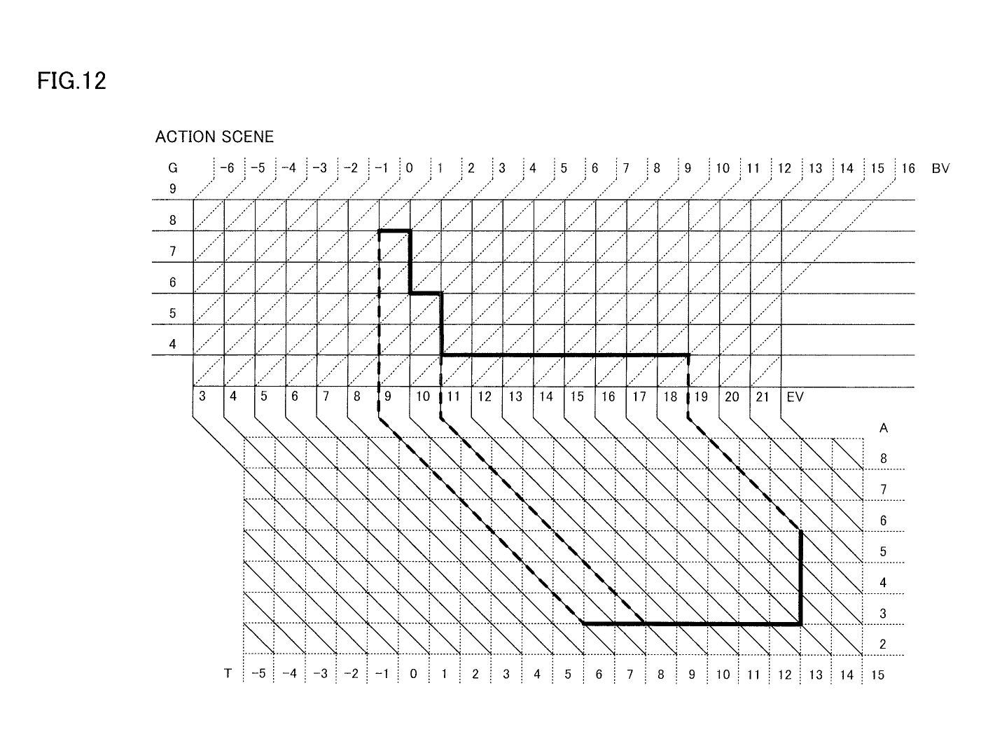

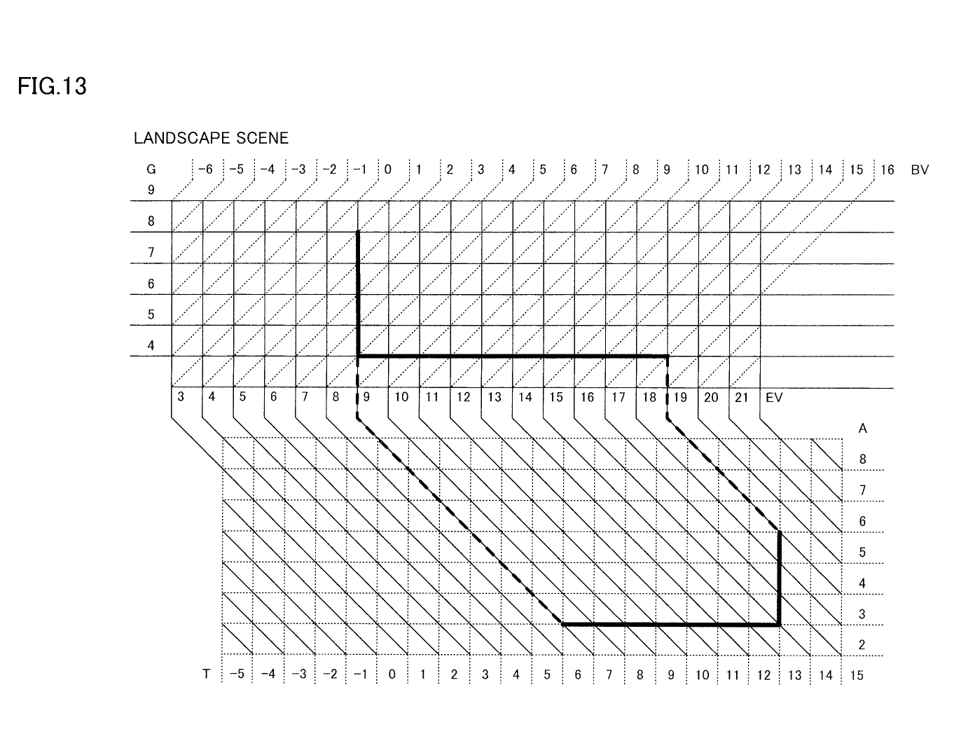

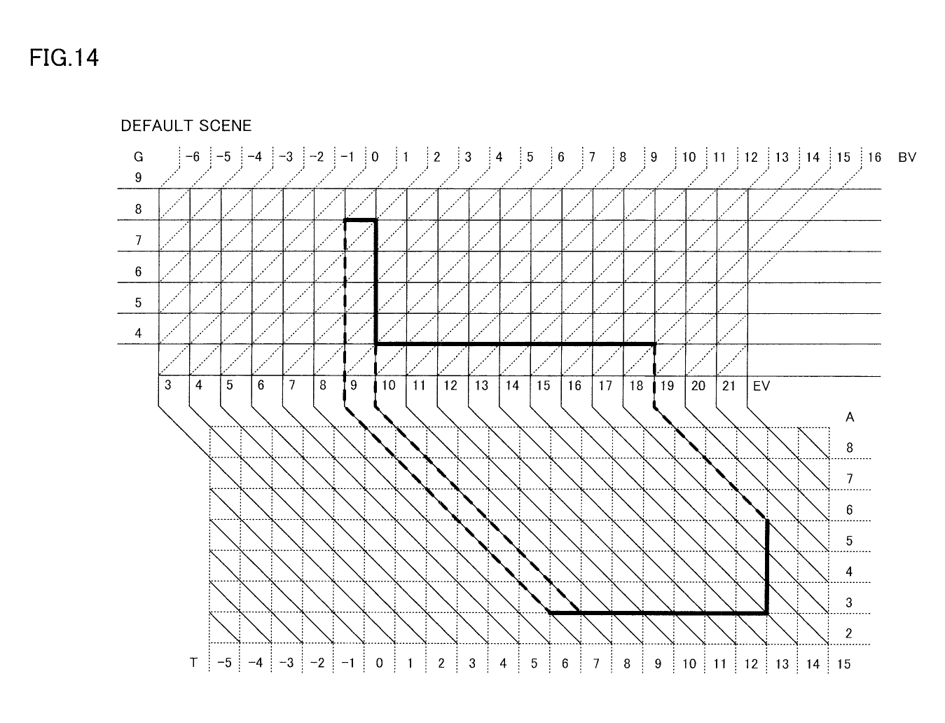

The coordinates (A, T, G) are detected on a bold line drawn on a program chart shown in FIG. 11 when the finalized scene is the night-view scene, and detected on a bold line drawn on a program chart shown in FIG. 12 when the finalized scene is the action scene. Moreover, the coordinates (A, T, G) are detected on a bold line drawn on a program chart shown in FIG. 13 when the finalized scene is the landscape scene, and detected on a bold line drawn on a program chart shown in FIG. 14 when the finalized scene is the default scene.

For example, when the finalized scene is the night-view scene and the calculated appropriate BV value is “3”, (A, T, G)=(3, 7, 7) is detected. Furthermore, when the finalized scene is the action scene and the calculated appropriate BV value is “8”, (A, T, G)=(3, 9, 4) is detected.

To the drivers 18b and 18c and the AGC circuit 20, the aperture amount, the exposure time, and the AGC gain specified by the coordinates (A, T, G) thus detected are set. If a change occurs in the finalized scene, then a program chart adapted to the changed finalized scene is specified and the specified program chart is set as the referring program chart.

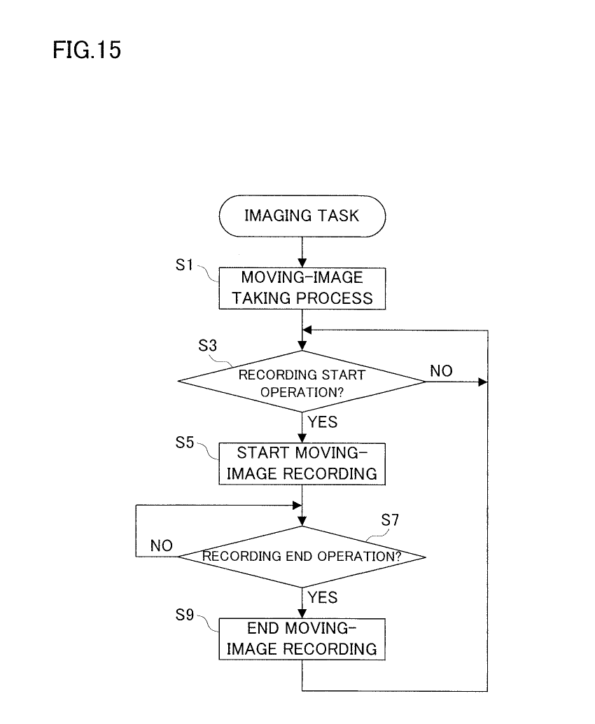

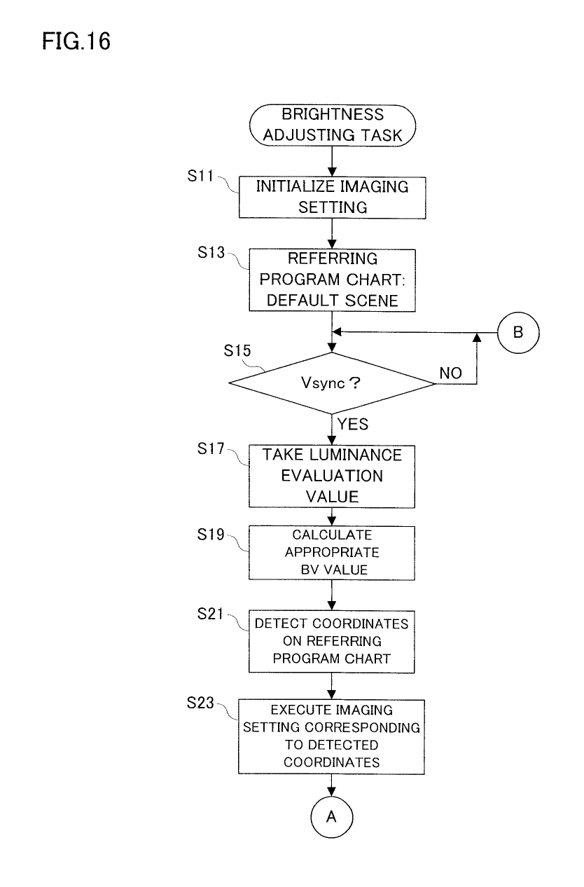

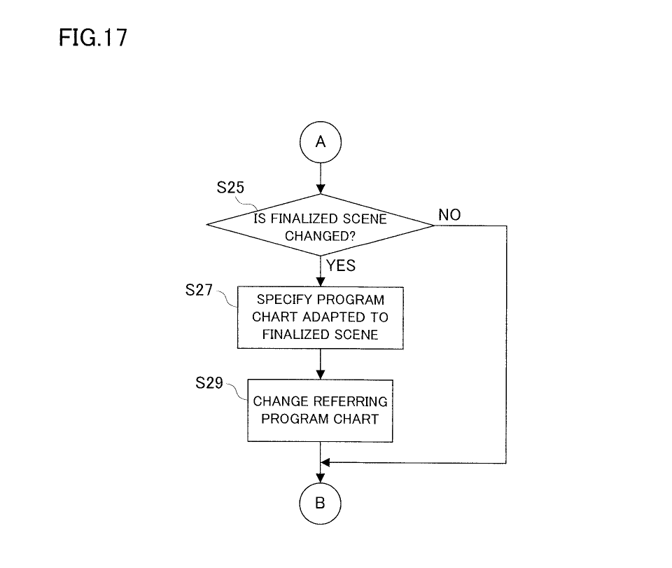

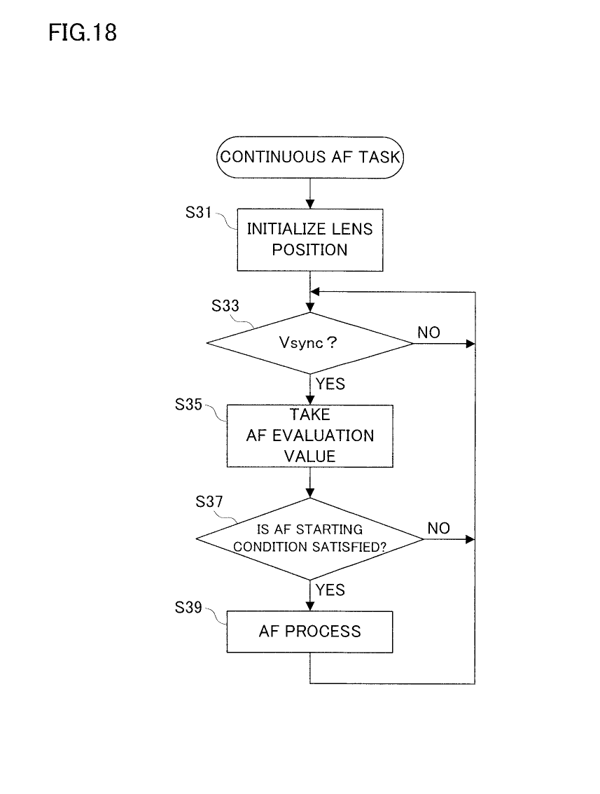

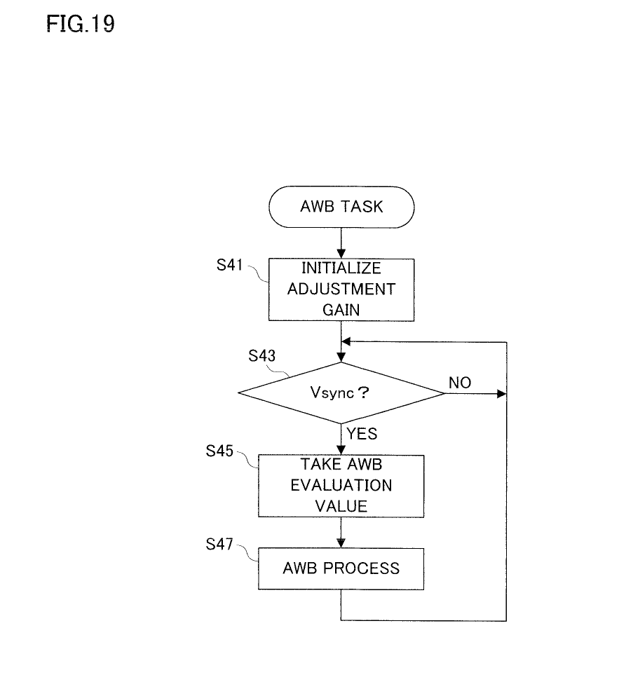

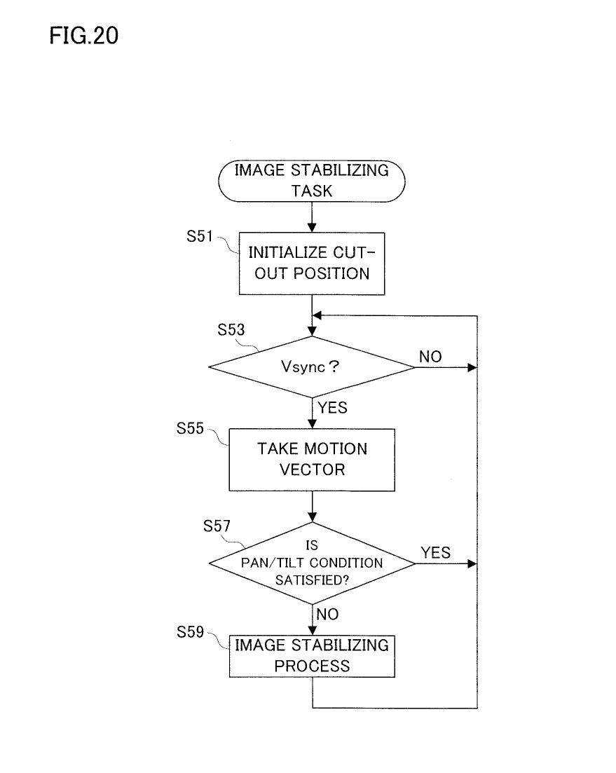

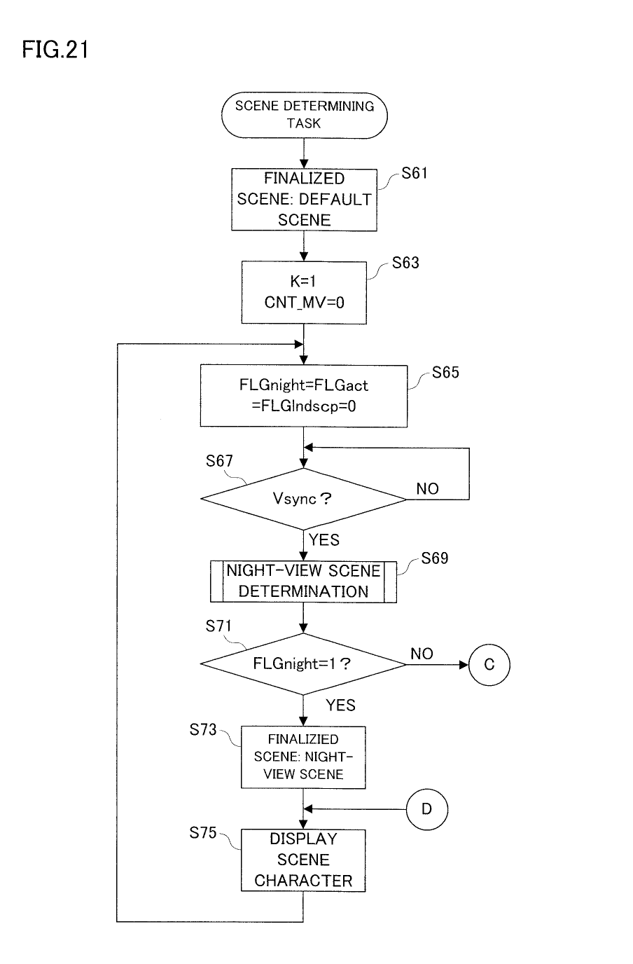

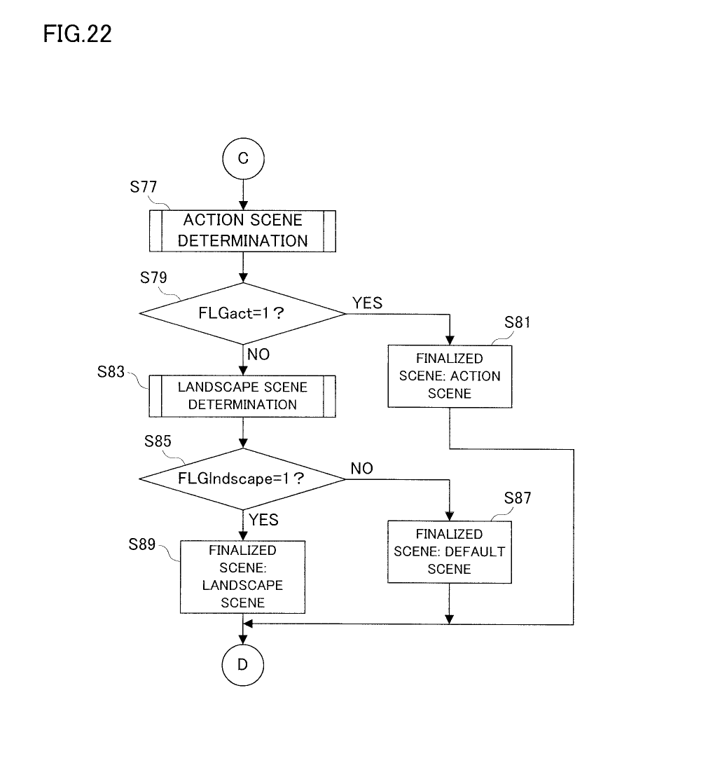

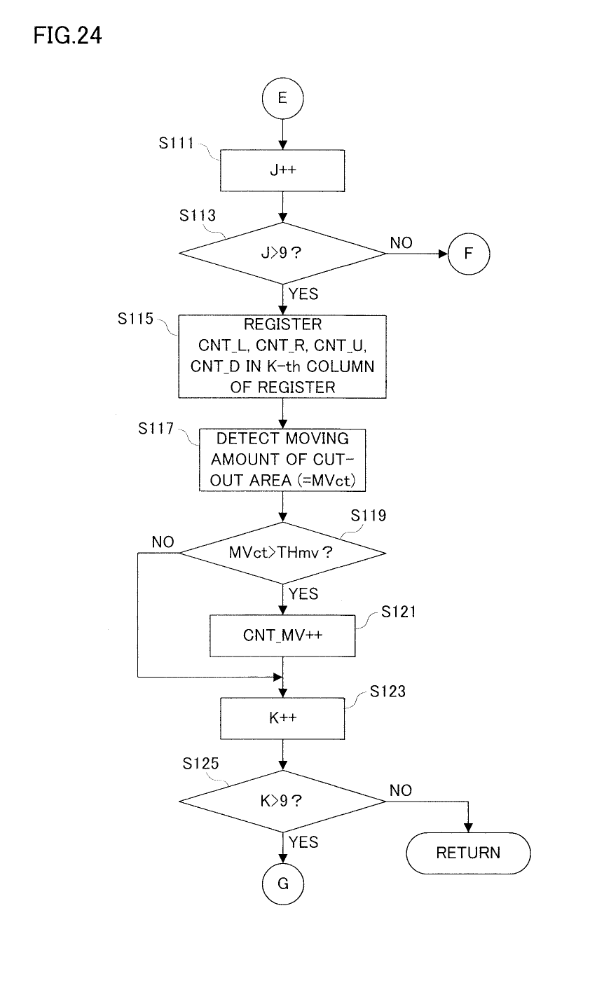

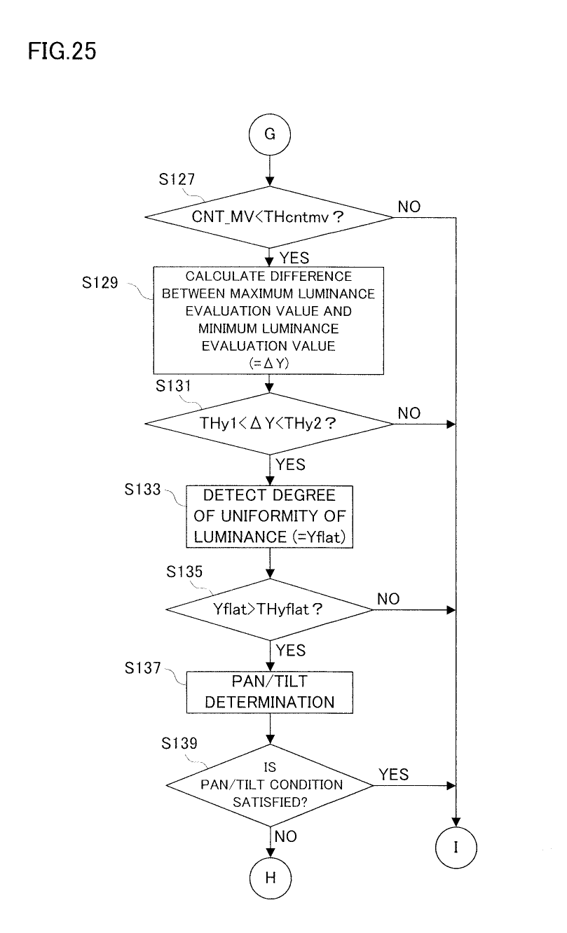

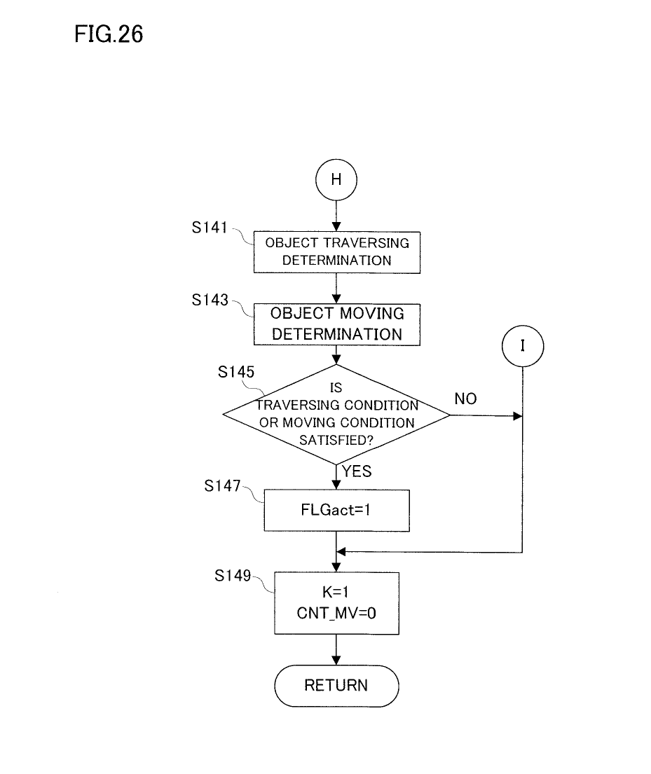

The CPU 48 processes a plurality of tasks including an imaging task shown in FIG. 15, a brightness adjusting task shown in FIG. 16 and FIG. 17, a continuous AF task shown in FIG. 18, an AWB task shown in FIG. 19, an image stabilizing task shown in FIG. 20, and a scene determining task shown in FIG. 21 to FIG. 26, in a parallel manner. It is noted that control programs corresponding to these tasks are stored in a flash memory (not shown).

With reference to FIG. 15, in a step S1, the moving-image taking process is executed. Thereby, the live view image is displayed on the LCD monitor 40. In a step S3, it is repeatedly determined whether or not the recording start operation has been performed. When a determined result is updated from NO to YES, the process advances to a step S5. In the step S5, the recording start command is applied to the I/F 46 in order to start the moving image recording. The I/F 46 reads out the image data accommodated in the YUV image area 34b through the memory control circuit 32, and writes the read-out image data into a moving-image file created in the recording medium 46.

In a step S7, it is determined whether or not the recording end operation is performed. When a determined result is updated from NO to YES, the process advances to a step S9 in which the recording end command is applied to the I/F 46 in order to end the moving image recording. The I/F 46 ends reading out the image data, and closes the moving-image file of a recording destination. Upon completion of closing the file, the process returns to the step S3.

With reference to FIG. 16, an imaging setting (=the aperture amount, the exposure time, and the AGC gain) is initialized in a step S11, and in a step S13, a program chart for the default scene is designated as the referring program chart. In a step S15, it is determined whether or not the vertical synchronization signal Vsync is generated and when a determined result is updated from NO to YES, the luminance evaluation values outputted from the luminance evaluating circuit 24 are taken in a step S17.

In a step S19, the appropriate BV value is calculated based on the taken luminance evaluation values, and in a step S21, the coordinates (A, T, G) corresponding to the calculated appropriate BY value are detected on the referring program chart. In a step S23, the aperture amount, the exposure time, and the AGC gain specified by the detected coordinates (A, T, G) are set to the drivers 18b and 18c and the AGC circuit 20.

In a step S25, it is determined whether or not the finalized scene has been changed. When a determined result is NO, the process returns to the step S15 while when the determined result is YES, the process advances to a step S27. In the step S27, the program chart adapted to the changed finalized scene is specified, and in a step S29, the referring program chart is changed to the specified program chart. Upon completion of the changing process, the process returns to the step S15.

With reference to FIG. 18, in a step S31, the position of the focus lens 12 is initialized, and in a step S33, it is determined whether or not the vertical synchronization signal Vsync has been generated. When a determined result is updated from NO to YES, the AF evaluation values outputted from the AF evaluating circuit 26 are taken in a step S35. In a step S37, it is determined whether or not the AF start-up condition is satisfied based on the taken AF evaluation values, and when a determined result is NO, the process returns to the step S33 while when the determined result is YES, the process advances to a step S39. In the step S39, the AF process is executed based on the taken AF evaluation values in order to move the focus lens 12 to a direction in which a focal point is present. Upon completion of the AF process, the process returns to the step S33.

With reference to FIG. 19, in a step S41, the white-balance adjustment gain referred to in the post-processing circuit 36 is initialized, and in a step S43, it is determined whether or not the vertical synchronization signal Vsync has been generated. When a determined result is updated from NO to YES, the AWB evaluation values outputted from the AWB evaluating circuit 28 are taken in a step S45. In a step S47, the AWB process is executed based on the taken AWB evaluation values in order to adjust the white-balance adjustment gain. Upon completion of the AWB process, the process returns to the step S43.

With reference to FIG. 20, in a step S51, the position of the cut-out area CT is initialized. In a step S53, it is determined whether or not the vertical synchronization signal Vsync has been generated. When a determined result is updated from NO to YES, the partial motion vectors outputted from the motion detecting circuit 30 are taken in a step S55. In a step S57, it is determined whether or not the pan/tilt condition described later has been satisfied. When a determined result is NO, the process returns to the step S53 while when the determined result is YES, the process advances to a step S59. In the step S59, the image-stabilizing process is executed by referring to the partial motion vectors taken in the step S55. The cut-out area CT moves to a direction in which the movement of the imaging surface resulting from the camera shake is compensated. Upon completion of the image-stabilizing process, the process returns to the step S53.

With reference to FIG. 21, in a step S61, the default scene is set as the finalized scene. In a step S63, the variables K and CNT_MV are set to “1” and “0”, respectively. In a step S65, the flags FLGnight, FLGact, and FLGlndscp are set to “0”.

In a step S67, it is determined whether or not the vertical synchronization signal Vsync has been generated, and when a determined result is updated from NO to YES, the night-view scene determining process is executed in a step S69. This determining process is executed based on the luminance evaluation value taken under the brightness adjusting task, and when the captured scene is determined to be the night-view scene, the flag FLGnight is updated from “0” to “1”.

In a step S71, whether or not the flag FLGnight indicates “1” is determined, and when a determined result is NO, the process directly advances to a step S77 and when the determined result is YES, the process advances to a step S73. In the step S73, the night-view scene is used as the finalized scene, and in a step S75, the graphic generator 42 is requested to output a character corresponding to the finalized scene. The character corresponding to the finalized scene is multi-displayed on the live view image. Upon completion of the process in the step S75, the process returns to the step S65.

In the step S77, the action-scene determining process is executed. This determining process is executed based on the partial motion vectors MV_1 to MV_9 taken under the image stabilizing task and the luminance evaluation values taken under the brightness adjusting task, and when the captured scene is determined to be the action scene, the flag FLGact is updated from “0” to “1”. In a step S79, it is determined whether or not the flag FLGact indicates “1”, and when a determined result is NO, the process advances to a step S83 while when the determined result is YES, the action scene is determined to be the finalized scene in a step S81, and then, the process advances to the step S75.

In the step S83, the landscape scene determining process is executed. This determining process is executed based on the luminance evaluation value taken under the brightness adjusting task, and when the captured scene is determined to be the landscape scene, the flag FLGlndscp is updated from “0” to “1”. In a step S85, it is determined whether or not the flag FLGlndscp indicates “1”, and when a determined result is NO, the default scene is determined to be the finalized scene in a step S87 while when the determined result is YES, the landscape scene is determined to be the finalized scene in a step S89. Upon completion of the process in the step S8 or S89, the process proceeds to a step S75.

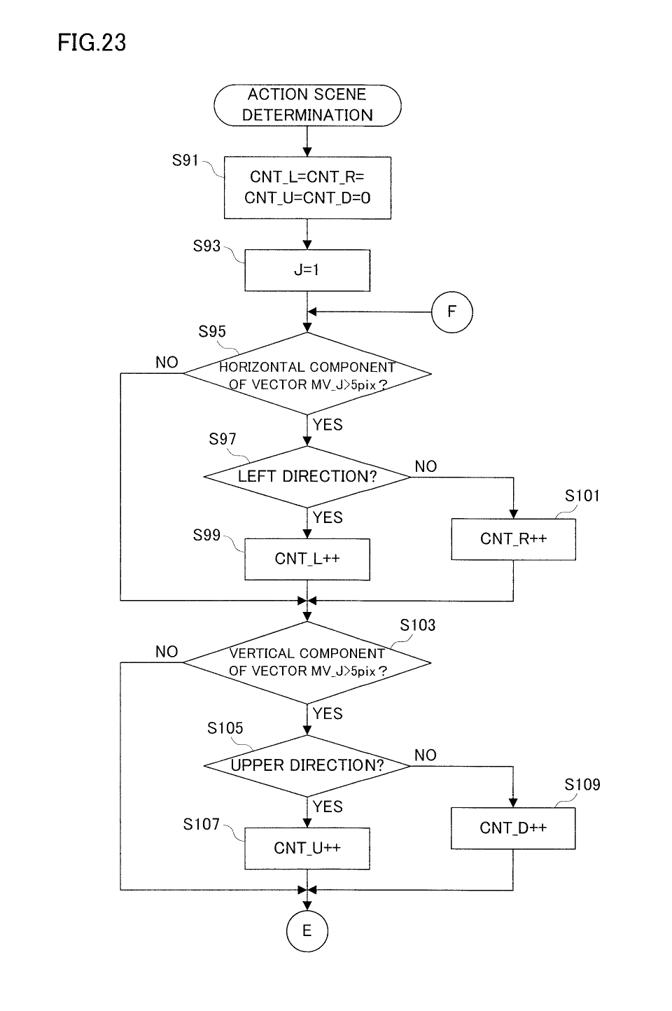

The action scene determining process in the step S77 is executed according to a subroutine shown in FIG. 23 to FIG. 26. Firstly, in a step S91, the variables CNT_L, CNT_R, CNT_U, and CNT_D are set to “0”, and in a step S93, the variable J is set to “1”.

In a step S95, it is determined whether or not the horizontal component amount of the partial motion vector MV_J exceeds an amount equivalent to the five pixels. When a determined result is NO, the process directly advances to a step S103, and when the determined result is YES, the process advances to the step S103 after passing through steps S97 to S101.

In the step S97, it is determined whether or not a direction of the horizontal component of the partial motion vector MV_J is a left direction. When determined result is YES, the variable CNT_L is incremented in the step S99 while when the determined result is NO, the variable CNT_R is incremented in the step S101.

In the step S103, it is determined whether or not the vertical component amount of the motion vector MV_J exceeds an amount equivalent to the five pixels. When a determined result is NO, the process directly advances to a step S111, and when the determined result is YES, the process advances to the step S111 after passing through steps S105 to S109.

In the step S105, it is determined whether or not whether or not a direction of the vertical component of the partial motion vector MV_J is an upper direction. When a determined result is YES, the variable CNT_U is incremented in the step S107 while when the determined result is NO, the variable CNT_D is incremented in the step S109.

In the step S111, the variable J is incremented. In a step S113, it is determined whether or not the variable J exceeds “9”. When a determined result is NO, the process returns to the step S95, and when the determined result is YES, the process advances to a step S115. In the step S115, values of the variables CNT_L, CNT_R, CNT_U, and CNT_D are registered in the K-th column of the register RGST1.

In a step S117, the moving amount of the cut-out area CT by the process in the above-described step S59 is detected as “MVct”, and in a step S119, it is determined whether or not the moving amount MVct exceeds the threshold value THmv. When a determined result is NO, the process advances directly to a step S123, and when the determined result is YES, the process advances to the step S123 after incrementing the variable CNT_MV in a step S121. In the step S123, the variable K is incremented. In a step S125, it is determined whether or not the variable K exceeds “9”. When a determined result is NO, the process returns to the routine at a hierarchical upper level, and when the determined result is YES, the process advances to processes subsequent to a step S127.

In the step S127, it is determined whether or not the CNT_MV falls below the threshold value THcntmv. When a determined result is NO, it is regarded that the movement of the scene image in the latest nine frames results from the camera shake, and then, the process advances to a step S149. On the other hand, when the determined result is YES, it is regarded that the movement of the scene image in the latest nine frames does not result from the camera shake, and then, the process advances to a step S129.

In the step S129, the maximum luminance evaluation value and the minimum luminance evaluation value are detected from among the 256 luminance evaluation values taken in the step S17, and the difference between the detected maximum luminance evaluation value and minimum luminance evaluation value is calculated as “ΔY”. In a step S131, it is determined whether or not the calculated difference ΔY belongs to a range sandwiched between the threshold values THy1 and THy2. When a determined result is NO, it is regarded that the luminance difference on the scene image is very small or very large, and the process advances to a step S149. On the other hand, when a determined result is YES, it is regarded that the luminance difference on the scene image is appropriate, and the process advances to a step S133.

In the step S133, the 32 luminance evaluation values respectively corresponding to the 32 divided areas where a letter “X” is drawn so that the center of the evaluation area EVA is an intersection point are detected from among the 256 luminance evaluation values taken in the step S17, and the degree of uniformity of the 32 detected luminance evaluation values is calculated as “Yflat”. In a subsequent step S135, it is determined whether or not the calculated degree of uniformity Yflat exceeds the threshold value THyflat.

When a determined result is NO, it is regarded that the description of the register RGST1 lacks reliability to determine the movement of the scene image, and the process advances to a step S149. On the other hand, when a determined result is YES, it is regarded that the description of the register RGST1 possesses the reliability to determine the movement of the scene image, and the process advances to a step S137.

In the step S137, it is determined whether or not the movement of the scene image in the latest nine frames satisfies the pan/tilt condition by referring to the description of the register RGST1. When the pan/tilt condition is satisfied, it is regarded that the movement to be noticed results from the pan/tilt behavior of the imaging surface. On the other hand, when the pan/tilt condition is not satisfied, it is regarded that the movement to be noticed does not result from the pan/tilt behavior of the imaging surface. When the pan/tilt condition is satisfied, the process advances from a step S139 to a step S149, and when the pan/tilt condition is not satisfied, the process advances from the step S139 to a step S141.

In the step S141, it is determined whether or not the movement of the scene image in the latest nine frames satisfies the object traversing condition by referring to the description of the register RGST1. In a step S143, it is determined whether or not the movement of the scene image in the latest nine frames satisfies the object moving condition by retelling to the description of the register RGST1.

When the object traversing condition is satisfied, it is regarded that the movement of the scene image over the period of the latest nine frames results from the traversing of the object. Moreover, when the object moving condition is satisfied, it is regarded that the movement of the scene image over the period of the latest nine frames results from the movement of the object present at the same position.

When neither the object traversing condition nor the object moving condition is satisfied, NO is determined in a step S145, and the process advances directly to a step S149. On the other hand, when either the object traversing condition or the object moving condition is satisfied, YES is determined in the step S145, and the process advances to the step S149 after updating the flag FLGact to “1” in a step S147. In the step S149, the variables K and CNT_MV are set to “1” and “0”, respectively, and thereafter, the process returns to the routine at a hierarchical upper level.

As is seen from the above description, the imager sensor 16 has the imaging surface capturing the scene and repeatedly outputs the raw image data. The outputted raw image data is amplified by the AGC circuit 20. The exposure amount of the imaging surface and the gain of the AGC circuit 20 are adjusted by the CPU 48 in a manner to match along any one of a plurality of program charts including a specific program chart adapted to the action scene (S17 to S29). Here, the CPU 48 determines whether or not the movement of the scene image that is based on the raw image data satisfies the first condition, based on the motion vectors outputted from the motion detecting circuit 30 (S127, S139, and S145), and determines whether or not the luminance of the scene image that is based on the raw image data satisfies the second condition, based on the luminance evaluation value outputted from the luminance evaluating circuit 24 (S131 and S135). Moreover, the CPU 48 permits the referring to the specific program chart when these determined results are both positive (S147, S79, and S81), and restricts or prohibits the referring to the specific program chart when at least one of the determined results is negative (S65).

Here, the first condition is equivalent to a logical AND of conditions, i.e., a condition under which the movement of the scene image does not result from the camera shake; a condition under which the movement of the scene image does not result from the pan/tilt behavior of the imaging surface; and a condition under which the movement of the scene image results from the traversing of the object or the movement of the object at the same position.

Furthermore, the second condition is equivalent to a logical AND of conditions, i.e., a condition under which the variance width (=ΔY) of the luminance of the scene image belongs to the range sandwiched between the threshold values THy1 and THy2; and a condition under which the degree of uniformity (=Yflat) of the luminance of the scene image exceeds the threshold value THyflat.

Therefore, the referring to the specific program chart is permitted when the movement of the scene image satisfies the first condition and the luminance of the scene image satisfies the second condition. In other words, even when the movement of the scene image satisfies the first condition, unless the luminance of the scene image satisfies the second condition, the referring to the specific program chart is restricted. This avoids an erroneous determination of whether or not the scene captured by the imaging surface is dynamic, by extension, an erroneous selection of the adjustment reference, and improves the imaging performance.

It is noted that in this embodiment, three parameters for adjusting the imaging condition are assumed, i.e., the aperture amount, the exposure time, and the AGC gain; however, in addition thereto, an emphasis degree of an edge and/or a chroma may be assumed. In this case, these degrees of emphasis need to be additionally defined to the program chart.

Although the present invention has been described and illustrated in detail, it is clearly understood that the same is by way of illustration and example only and is not to be taken by way of limitation, the spirit and scope of the present invention being limited only by the terms of the appended claims.

What is claimed is:

1. An electronic camera, comprising:
an imager which repeatedly outputs an image representing a scene captured by an imaging surface;
an adjuster which adjusts an imaging condition by referring to any one of a plurality of adjustment references including a specific adjustment reference suitable for a dynamic scene;
a permitter which permits the referring by said adjuster to the specific adjustment reference when a movement of the image outputted from said imager satisfies a first condition and a luminance of the image outputted from said imager satisfies a second condition; and
a restrictor which restricts the referring by said adjuster to the specific adjustment reference when at least one of the first condition and the second condition is not satisfied.

2. An electronic camera according to claim 1, wherein the first condition includes a first passive condition that a cause of the movement is different from a camera shake.

3. An electronic camera according to claim 1, wherein the first condition includes a second passive condition that a cause of the movement is different from pan and/or tilt behavior of the imaging surface.

4. An electronic camera according to claim 1, wherein the first condition includes a positive condition that a cause of the movement is a movement of an object present in the scene.

5. An electronic camera according to claim 1, wherein the second condition includes a variance width condition that a variance width of the luminance is contained in a predetermined range.

6. An electronic camera according to claim 1, wherein the second condition includes a uniformity degree condition that a degree of uniformity of the luminance exceeds a reference.

7. A computer program embodied in a tangible medium, which is executed by a processor of an electronic camera provided with an imager which repeatedly outputs an image representing a scene captured by an imaging surface, said program comprising:
an adjusting instruction to adjust an imaging condition by referring to any one of a plurality of adjustment references including a specific adjustment reference suitable for a dynamic scene;
a permitting instruction to permit the referring in said adjusting instruction to the specific adjustment reference when a movement of the image outputted from said imager satisfies a first condition and a luminance of the image outputted from said imager satisfies a second condition; and
a restricting instruction to restrict the referring in said adjusting instruction to the specific adjustment reference when at least one of the first condition and the second condition is not satisfied.

8. An imaging controlling method executed by an electronic camera provided with an imager which repeatedly outputs an image representing a scene captured by an imaging surface, said image controlling method, comprising:
an adjusting step of adjusting an imaging condition by referring to any one of a plurality of adjustment references including a specific adjustment reference suitable for a dynamic scene;
a permitting step of permitting the referring in said adjusting step to the specific adjustment reference when a movement of the image outputted from said imager satisfies a first condition and a luminance of the image outputted from said imager satisfies a second condition; and
a restricting step of restricting the referring in said adjusting step to the specific adjustment reference when at least one of the first condition and the second condition is not satisfied.
